(19) United States
(12) Patent Application Publication
(10) Pub. No.: US 2026/0196063 A1
(43) Pub. Date: Jul. 9, 2026

(54) Method and System for Controlling a Function of a Vehicle by Means of a Terminal of a User

(71) Applicant: Bayerische Motoren Werke Aktiengesellschaft, Muenchen (DE)

(72) Inventors: Thomas Ewender, Bad Aibling (DE); Johannes Feldmaier, Ebersberg (DE); Simone Camberg, Muenchen (DE); Artur Hubert, Muenchen (DE)

(21) Appl. No.: 19/126,011

(22) PCT Filed: Aug. 16, 2023
(86) PCT No.: PCT/EP2023/072504

§ 371 Date: Apr. 30, 2025

(30) Foreign Application Priority Data
Nov. 11, 2022 (DE) 10 2022 129 841.8

(51) Int. Cl. G06V 20/59; G06V 10/10; G06V 10/24; G06V 10/26; G06V 20/62

(52) U.S. Cl. CPC G06V 20/59; G06V 10/10; G06V 10/24; G06V 10/26; G06V 20/62; G06V 2201/02

(57) ABSTRACT

A method for controlling a function of a vehicle by means of a terminal of a user includes a step of capturing image data using at least one image capture apparatus in an interior of the vehicle, wherein the image data contains at least one view of the terminal of the user. The method also includes recognizing content on the terminal of the user by analyzing the image data to generated recognized content. The method further includes assigning the recognized content to a function of the vehicle, and controlling the function of the vehicle depending on the recognized content.

The present application is the U.S. national phase of PCT Application PCT/EP2023/072505 filed on Aug. 16, 2023, which claims priority of German patent application No. 10 2022 129 841.8 filed on Nov. 11, 2022, the entire contents of which are incorporated herein by reference.

### TECHNICAL FIELD

The present disclosure invention relates generally to the field of vehicles, and more particular, controlling a function of a vehicle.

### BACKGROUND

Modern vehicles have a multiplicity of functions that a user can control, i.e. can open, run, stop, configure, etc., for example. These can include in particular functions of the infotainment system such as entering a navigation destination, playing a piece of music, calling a contact, or the like. These functions of the infotainment system are usually controlled by the user interacting directly with the vehicle, for instance by actuating pushbuttons or touching a touchscreen or even by voice control or gesture control.

The operation in the vehicle itself can sometimes be tedious, however, for instance if data such as a navigation destination or a title of a piece of music has to be typed in via a keypad on a touchscreen or selected using a controller. Input of this type is often easier on a terminal of a user, for instance a smartphone. In some cases, the data even already exists on the smartphone, for example if a user has already listened to a certain song on his smartphone that he now wants to hear in the vehicle.

Methods are known for controlling vehicle functions by means of a terminal of a user. However, these require the terminal to be paired with the vehicle for transferring data from the terminal of the user to the vehicle. For example, a smartphone can be paired wirelessly with the vehicle via Bluetooth or a WLAN hotspot in the vehicle. It is also known to transfer data from a terminal to a vehicle via a Cloud service. Although this saves the input in the vehicle, it requires suitable pairing or setup of a particular service beforehand (at least once). While this may still be a viable approach for a vehicle owner, it inconvenient in a rental car or for is occasional passengers, for example.

There is a need, therefore, to simplify the control of a function of a vehicle. In particular, there is a need to provide simplified control of a vehicle function by means of a terminal of a user.

### SUMMARY

The above-described need, as well as others, are met by at least some embodiment disclosed herein For example, a function is controlled by means of a terminal of a user, which is captured by an image capture apparatus, such as a camera, in the interior of the vehicle, wherein the function is controlled on the basis of recognizing content on the terminal of the user.

A first aspect relates to a method for controlling a function of a vehicle by means of a terminal of a user. The method may be computer-implemented. The method comprises capturing image data by means of at least one image capture apparatus in the interior of a vehicle, wherein the image data contains at least one view of a terminal of the user, recognizing content on the terminal of the user by analyzing the image data, assigning the recognized content to a function of the vehicle, and controlling the function of the vehicle depending on the recognized content.

The aforementioned method according to the first aspect is thus based in particular on analyzing image data captured by means of an image capture apparatus such as a camera. The image capture apparatus acquires a view of the terminal of the user so that content on the terminal, in particular content that can be displayed on a display of the terminal, can be recognized. The recognized content is assigned to a function of the vehicle, in other words the nature of the content is recognized so that the content can be assigned to a vehicle function, with the result that this function can then be controlled, in particular opened or configured, depending on the recognized content, for instance by the recognized content.

This procedure significantly simplifies the control of a vehicle function because there is no need for any pairing, connection or other electronic connection of the terminal to the vehicle. Therefore, for example, a vehicle function can also be controlled by users who do not have to connect their terminal to the vehicle first. The control can be performed, for example, simply by holding a smartphone into a camera in the interior of the vehicle. From the acquired image of the smartphone, more precisely from the display having content presented thereon, an associated vehicle function can be opened quickly and easily with the relevant content. The term “vehicle” used herein refers in particular to a passenger car, including all types of motor vehicles, hybrid and battery-powered electric vehicles and vehicles such as vans, buses, trucks, delivery vans and the like.

The term “function of a vehicle” (synonymous with the term “vehicle function”) as used herein shall be understood to mean in particular a function of an infotainment system of a vehicle. This can comprise proprietary applications from the vehicle manufacturer and/or applications implemented by third-party suppliers. The control of a vehicle function can comprise in particular opening or running a vehicle function, which is associated with recognized content, depending on the recognized content. The control of a vehicle function can also comprise, however, just displaying data for recognized content or the associated vehicle function (if applicable, together with the recognized content), for instance on a screen of the vehicle, in particular on a display of the infotainment system.

The term “terminal” of a user as used herein shall be understood to mean in particular a device such as a mobile device that is not part of the vehicle but is in the possession of a user. Within the meaning of the present invention, there is no need for the terminal to be electronically paired directly or indirectly to the vehicle in any way. This does not exclude the possibility of the terminal being paired to the vehicle for other purposes, however. In particular, the terminal is set up to present content, in particular to show content on a display. The terminal can be a smartphone, for example, or a smartwatch, a tablet, a laptop and the like. In particular, the user of a terminal can be the driver of the vehicle. It shall be understood, however, that also a front passenger and, in principle, every vehicle occupant who gets into a suitable position with a terminal in a suitable manner can be a user of the terminal within the meaning of the invention.

The term “content” of a terminal as used herein refers in particular to information presented on a display device, such as a display, of a terminal. The content need not necessarily be displayed on the terminal in an app that corresponds by its type to the vehicle function. For example, the content can consist merely of unformatted text or machine-readable code. That being said, the content can also be examined in terms of its presentation, such as text style, colors, forms, logos or the like, which can be used to identify the vehicle function. A code can also contain more than just a text, for instance additionally details of the nature of the content or even a corresponding control code for the vehicle function.

The term “image capture apparatus” used herein refers in particular to a camera, in particular a digital camera. The camera can acquire stationary images (photos) or moving images (videos). The image capture apparatus can capture or acquire such an image and output corresponding image data.

The terms “comprises”, “contains”, “includes”, “involves”, “has”, “having” or any other variant thereof, as may be used herein, are intended to cover a non-exclusive inclusion. For instance, a method or an apparatus that comprises or has a list of elements is not necessarily restricted to these elements but can include other elements that are not listed explicitly or are inherent to such a method or apparatus.

In addition, unless explicitly stated otherwise, “or” refers to an inclusive or and not to an exclusive “or”. For example, a condition A or B is satisfied by one of the following conditions: A is true (or is present) and B is false (or not present), A is false (or not present) and B is true (or present), and both A and B are true (or present).

The terms “a” or “an” as used herein are defined in the sense of “one or more”. The terms “another” and “a further” and every other variant thereof shall be understood to mean “at least one further”.

The term “plurality” as used herein shall be understood to mean “two or more”.

The term “configured” or “set up” to perform a certain function (and variants thereof) shall be understood within the meaning of the invention to mean that the relevant apparatus already exists in a form or setting in which it can carry out the function, or at least can be adjusted, i.e. configured, such that it can carry out the function after suitable adjustment. For example, the configuration can be made by way of suitable adjustment to parameters of a process flow or to switches or the like for activating and/or deactivating functionalities or settings. In particular, the apparatus can have a plurality of predefined configurations or operating modes, so that the configuring can be performed by selecting one of these configurations or operating modes.

Various embodiments of the method are described below, each of which can be combined in any way with one another and with the further described other aspects of the invention, unless this is explicitly ruled out or technically impossible.

In some embodiments, the method comprises before the capturing of the image data by means of the image capture apparatus additionally the following: capturing monitoring data for at least part of the interior of the vehicle by means of at least one monitoring apparatus, and verifying (i.e. checking) whether the terminal of the user is located at least partially in a specified region of the monitoring data, wherein the capturing of the image data by means of the image capture apparatus is carried out only if it is verified that the terminal of the user is located at least partially in the specified segment.

The method can be made more reliable by this measure, which precedes the actual recognition of content on the terminal. Image analysis is not carried out constantly, which would not only require additional computing power but also, for instance, might lead to unwanted results if a user may have no intention of controlling a vehicle function. The image data is captured for possible recognition of content on the terminal only when a user is actually holding a terminal into a capture region (the specified region). This can be done using a monitoring apparatus that may be present anyway in the vehicle, for instance for monitoring the driver for other purposes. The monitoring data as such, however, may not be suitable for recognizing content presented on a terminal, which is why image data is then captured, as explained above, when it is positively verified that a terminal is located in the specified region. It is possible, however, that the monitoring apparatus is also an image capture apparatus, as explained in greater detail below. In some embodiments, the method additionally comprises the following: recognizing a state of the terminal by analyzing the monitoring data and verifying (i.e. checking) whether the recognized state is suitable for recognizing content on the terminal of the user, wherein the recognizing of content on the terminal of the user by analyzing the image data is carried out only if it is verified that the state of the terminal is suitable for recognizing content on the terminal. This measure increases the reliability of the method because a check is made before the actual image recognition as to whether the terminal is in a “suitable state”, i.e., for example, is being held in a correct orientation, is not covered, and the like, as explained in greater detail below. This can avoid unnecessary image analyses that would anyway be highly unlikely to deliver a valid result. In addition, it can happen that a user is holding his terminal (possibly unintentionally) in the specified segment but has no intention of controlling a vehicle function. In particular with the previously explained check of the monitoring data. The reliability of the method can be further increased in particular in combination with the previously described check of the monitoring data as to whether the terminal is in the specified region. In other words, it is advantageous if it is first verified whether a terminal is located in the specified region, and only in the case of a positive verification is it further verified whether it is in a “suitable state”.

The following embodiments describe possible states of the terminal that are examined first before the actual image recognition is activated. A state of the terminal does not necessarily refer to an operating state of the terminal itself, but in particular refers to a relationship between terminal and vehicle. The state counts as suitable if a negative verification (i.e. “unsuitable”) is not made for any of the following embodiments. Just one negative verification can mean that content on a terminal cannot be recognized, for instance because the user is holding his terminal unsuitably. Therefore, preferably, all verifications are meant to have a positive outcome before the image recognition is triggered. It shall be understood, however, that there can be cases in which despite a negative verification in one case (or even a plurality of cases), recognition of content on a terminal could still be carried out successfully.

In some embodiments, the state comprises an orientation (the positioning) of the terminal in the interior of the vehicle, wherein it is verified that the recognized state is unsuitable for recognizing content on the terminal if an angle of view of the image capture apparatus onto the terminal lies outside a specified range. In particular, recognizing content on the terminal can be impossible or at least more difficult if the terminal is held at too great an angle, is skewed or the like with respect to the image capture apparatus.

The orientation of the terminal in three dimensions can also be ascertained easily here if the monitoring data is image data. For example, if an angle between two edges of a terminal (assumed to be rectangular), which should be parallel to each other, is too large in the image, this is an indicator that the terminal is held at too great an angle (skewed). Also, if the separation between t parallel edges, which are also parallel in the image, is too small, this can likewise lead to the conclusion that the terminal has an unsuitable orientation (skew) relative to the camera. It is also possible to ascertain by means of the distance between the edges a separation between the terminal and image capture apparatus. If this lies outside a specified range, recognition of content on the terminal can be impossible or at least more difficult, i.e. if the terminal is too close to, or too far away from, the image capture apparatus.

In some embodiments, the state comprises a portion of the terminal, which portion is visible to the image capture apparatus, wherein it is verified that the recognized state is unsuitable for recognizing content on the terminal if the visible portion is less than a specified limit value. In this case, it can be verified in particular whether fingers are in front of the terminal or even most of the hand, which can indicate that the terminal is not facing, or not facing enough, the image capture apparatus with the displayed content. Also, it is highly unlikely that activating the image recognition is practical if only a small part of the front face of the terminal is visible, for instance because the user is covering part of the display with his hand.

In some embodiments, the state comprises a movement of the terminal, wherein it is verified that the recognized recognizing state is unsuitable for content on the terminal if the movement is greater than a specified limit value. For reliable recognition of content on a terminal, it is advantageous if the terminal is not moving too much. It should be mentioned that this does not necessarily mean that a user must hold his terminal still. Too rapid a movement, however, can absolutely indicate that the terminal is being moved through the capture region only briefly or unintentionally, and there is no wish or intention to control a vehicle function. A movement can be identified by deriving the coordinates of the terminal, for instance from the captured monitoring data. Since a user usually holds his terminal in his hand, the coordinates of the user's hand can also be used for this purpose. This data may already be available from a skeleton model of the user which is created anyway for other purposes.

In some embodiments, the method comprises before the recognizing of content on the terminal of the user by analyzing the image data additionally the following: determining a segment of the image data, which segment represents the terminal, from the monitoring data (in particular from the specified region described above), and verifying whether the segment contains image data suitable for recognizing content on the terminal of the user, wherein the recognizing of content on the terminal is only carried out if it is verified that the segment contains image data suitable for recognizing content on the terminal. In other words, the monitoring data can be used to determine the segment of the image data that is relevant to the recognition. Coordinates can be used here to determine, for example, the location of a display of the terminal. For example, the image data may be unsuitable for recognizing content if the display of the terminal is not even switched on, which can be identified, for example, via brightness differences in the image data. In addition, the light conditions for recognizing content on the terminal may be unsuitable, for instance because the display appears too dark. This can be implemented, for example, by identifying pixels and their saturation, for example if the number of pixels having a certain saturation (minimum saturation) is less than a specified value.

In some embodiments, the image data is captured in the visible region of light by means of the image capture apparatus. This can be done by means of an RGB camera. This method is most suitable for recognizing content displayed on a display of a terminal.

In some embodiments, the monitoring data is by means of the monitoring apparatus, which is set up to capture monitoring data for at least part of the interior of the vehicle, wherein the monitoring data preferably comprises as image data in the infrared light region (IR) and/or as three-dimensional model data. Driver monitoring systems usually work such IR with cameras. This method is suitable for monitoring a vehicle interior because image data captured in the IR region is resilient to differing light conditions. In other words, this method delivers reliable results both in strong sunlight and in darkness (in particular compared with image data in the visible region of light). Data in a three-dimensional model, for instance data acquired using a time-of-flight camera, allows a more detailed three-dimensional view of the vehicle interior.

In some embodiments, the recognizing of content comprises recognizing text and/or recognizing machine-readable code. Recognition of this type can use known methods such as text recognition from the image data by means of OCR. In order to assign the recognized text (or code) to a vehicle function, classification or parsing can then be carried example, it can be identified from recognized text whether it is a title of a piece of music or an address. On the basis thereof, it is then possible accordingly, for example, to open an app from a streaming provider in order to play the recognized piece of music, or to run the navigation system with appropriate destination directions to the recognized address.

A second aspect relates to a system for data processing, having at least one processor, which is configured to perform the methods discussed above.

In some embodiments, the system additionally comprises at least one image capture apparatus, which is set up to capture image data in the visible region (RGB) of light. As explained above, content of a terminal, in particular content displayed on a display of a terminal, can be recognized in this manner.

In some embodiments, the system additionally comprises at least one monitoring apparatus, which is set up to capture image data in the infrared light region (IR) and/or three-dimensional model data. As explained above, it is advantageous to monitor the interior of a vehicle by means of an infrared camera or a time-of-flight camera. A third aspect of the invention relates to a computer program containing instructions which, on being executed on a system according to the second aspect, cause this system to perform the method according to the first aspect.

In particular, the computer program can be stored on a non-volatile data storage medium. This is preferably a data storage medium in the form of an optical data storage medium or a flash memory module. This can be advantageous when the computer program as such is meant to be handled independently of a processor platform on which the one program or the plurality of programs are to be executed. In another implementation, the computer program can be available as a file on a data processing unit, in particular on a server, and can be downloaded via a data connection, for example the Internet or a dedicated data connection, for instance a proprietary or local area network. In addition, the computer program can have a plurality of interacting individual program modules.

The system according to the second aspect can accordingly have a program memory in which is stored the computer program. Alternatively, the system can also be set up to access via a communication connection an external computer program that is available, for example, on one or more servers or other data processing units, in particular in order to exchange therewith data that is used during the course of the method or the computer program or constitutes outputs from the computer program.

The features and advantage explained with reference to the first aspect also apply correspondingly to the further aspects discussed above.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a flow diagram of a method according to one embodiment;

FIG. 2 shows a view of a vehicle interior containing a terminal held into a recognition region by a user; and

FIG. 3 shows a view of a terminal with displayed content.

### DETAILED DESCRIPTION

The same reference signs are used consistently in the figures for the same or corresponding elements the invention.

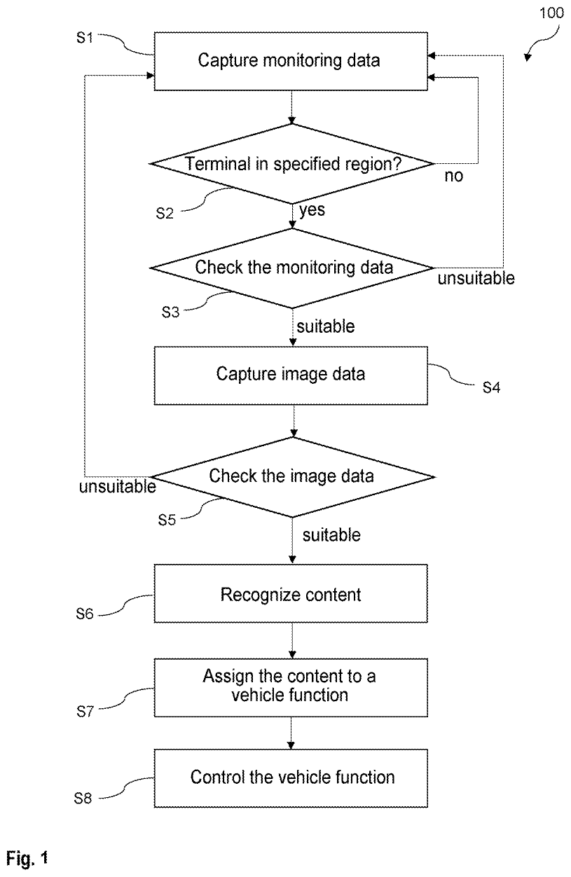

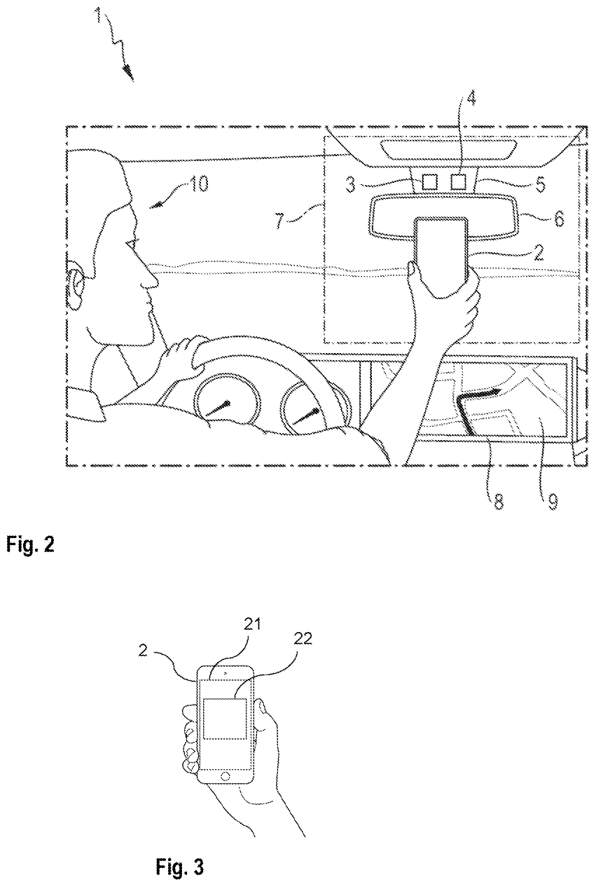

FIG. 1 shows a method 100 for controlling a vehicle function. The method 100 can be executed in particular in a data processing system of the vehicle (not shown). The method 100 is explained below also with reference to FIG. 2 and FIG. 3. FIG. 2 shows a segment of a vehicle interior 1 containing a driver as the user 10 of a smartphone as an example of a terminal 2. FIG. 3 shows a smartphone 2 in the hand of a user with content 22 (indicated schematically as a box) displayed on the display 21.

In a step S1, monitoring data is captured for at least part of the vehicle interior 1. The vehicle can be equipped with a driver monitoring system (DMS), which monitors the driver and possibly also other parts of the vehicle interior 1. This monitoring can be permanently active during the journey (i.e. in particular starting and ending with the switching-on and switching-off respectively of the ignition). For this purpose, a monitoring apparatus 3 can be arranged in the vehicle interior 2, for instance in the base 5 of the interior mirror 6. From this position, the driver 10 is easily visible and/or large parts of the vehicle interior 1 are also easily visible.

An infrared (IR) camera (e.g. a near infrared (NIR) camera) can be used. An IR image is well-suited to the monitoring because it is resilient to changing light conditions, for example even in strong sunlight. Equally, acquisitions are possible in darkness. It shall be understood that a corresponding IR light source can be present. It is also conceivable to create a three-dimensional model of the driver 10 and/or of the vehicle interior 1, for instance by means of a time-of-flight (TOF) camera. Distances to the camera and thus distances between objects and their movements can be calculated by means of the three-dimensional model. The captured monitoring data can be used in a step S2 to verify whether the terminal 2 is located in a specified region 7 (indicated by dashed lines in FIG. 2). This region 7 is a segment of the monitoring data; in the case of (IR) image data, this can be simply a two-dimensional region that was determined as suitable for the recognition of content presented on a terminal. In the vehicle interior, this can correspond to a region in the vicinity of the camera 3 (or of the camera 4, see below). The arrangement in the base 5 of the interior mirror 6 in the center of the vehicle is also easily accessible to a user for bringing a terminal 2 into position in the region 7 in a suitable manner for performing the method. It shall be understood that the region 7 indicated in FIG. 2 is purely by way of example. The position, size and shape of the region 7 can be adjusted to suit desired requirements.

The following steps of the method 100 are carried out advantageously only when the terminal 2 enters the region 7. This means that the method can be carried out more reliably, because not all the monitoring data is analyzed, for instance including when the terminal 2 is not even in the field of view of the camera 3 (or of the camera 4, see below). In addition, this can largely prevent the method 100 from being carried out unintentionally, because the user 10 usually does not bring his terminal 2 into the region 7, for instance as this requires him to raise his together with the terminal 2, as shown in FIG. 2.

If it is verified that the terminal 2 is located in the region 7, the checking of the monitoring data, advantageously only that monitoring data from the region 7, is performed a step S3. If not, the method 100 starts from the beginning at step S1. The checking is performed in particular on the basis of the criteria described below.

For reliable recognition of a presented content, the terminal 2 must be held in an orientation that is neither too tilted nor too skewed. This can be performed by comparing opposite edges of the terminal 2 in the monitoring data, which ideally are parallel to each other and have a certain separation (which would correspond to a straight orientation of the terminal 2 relative to the camera 3 (or camera 4)). If, however, an angle between opposite edges is too large, or a separation is too small, it can be inferred therefrom that the terminal 2 is tilted or skewed too much. The monitoring data is then accordingly categorized in both cases as unsuitable.

In addition, the terminal 2 must not be covered, for instance by the hand of the user 10, which can be an indicator that the display 21 of the terminal 2 is not in the viewing region or at least that large parts of the display 21 are covered by fingers or parts of the hand of the user 10. The monitoring data is then accordingly categorized in both cases as unsuitable.

Furthermore, too rapid a movement of the terminal 2 can also lead to categorizing the monitoring data as unsuitable. Firstly, recognizing content 22 is more reliable if the terminal 2 is not being moved too much. Secondly, a rapid movement of the terminal 2 in the region 7 can be an indication of it entering the region 7 unintentionally. A movement can be determined, for example, via the coordinates of the terminal 2 from the monitoring data or else from the coordinates of the hand of the user 10, in each case by deriving the corresponding position coordinates.

If the monitoring data was categorized as suitable, i.e. all the criteria of the above-described criteria have been categorized as suitable, image data is now captured in a step S4 by means of an image capture apparatus 4. Otherwise, the method 100 starts from the beginning at the image is step S1. Before capturing data, it advantageous to wait until an associated image signal processor (ISP) has completed an adjustment so that the exposure control used to capture the image data can be suitably adjusted accordingly.

In particular, the image capture apparatus 4 can be a camera 4 that captures image data in the visible region of light and can therefore be designated an RGB camera. Although an IR camera or TOF camera as the monitoring apparatus 3 suitable delivers a image under very different light conditions, the monitoring data 3 does not then contain any colors (RGB). These are needed, however, for recognizing content 22 presented (in the visible region of light) on a terminal 2, for instance on a display 21 of a smartphone (cf. FIG. 3). In an IR image, a terminal 2 such as a smartphone can be recognized merely as a (usually) substantially rectangular object, on which, in the best case, the display 21 can be distinguished as a rectangular monochrome surface. Although the monitoring apparatus 3 and the image capture apparatus 4 are shown in FIG. 2 as separate units, these can also be in combined unit, which in particular can be an RGB-IR camera, i.e. a camera delivering image data in both the RGB region and the IR region.

The image capture apparatus 4 can be arranged in particular also in the base 5 of the interior mirror 6. Therefore, the viewing regions of the monitoring apparatus 3 and of the image capture apparatus 4 can be assumed to be largely congruent, at least in the region 7 (or even substantially congruent if the monitoring apparatus 3 and image capture apparatus 4 are embodied as a unit). Thus in particular image data located in region 7 is captured.

In the image data, a segment that corresponds to the display 21 (or to the entire terminal 2 as a maximum) can be determined from the region 7. The corresponding 2D coordinates, in particular four corner coordinates, can be determined from the monitoring data. The further image processing can use this information about this segment of the image data, which segment is defined by the precise position and orientation of the terminal 2 or of its display 21, for the subsequent checking of the image data (step S5). The subsequent image analysis (step S6) can then be advantageously restricted to this segment because all the regions outside the display 21 (or at least outside the terminal 2) are irrelevant anyway to the actual recognition of content.

The captured image data is now checked in a step S5 before the further processing. In particular it is checked whether the display 21 of the terminal 2 is actually switched on. This can be done by comparing the brightness of pixels within the segment of the image data defining the display 21, as described above, and of pixels outside. In addition, the light conditions are checked, where the image can be categorized as too dark, for example, if more than a certain number of pixels have a saturation value below a limit value. If both criteria are positively assessed, the image data is categorized as suitable for the content recognition. Otherwise, the method 100 starts from the beginning at step S1.

If the image data was categorized as suitable, this data is now analyzed by image analysis. First, content 22 presented on the terminal 2 is recognized (step S6). This can be done in particular using known text recognition methods (OCR) if the content is a text, or methods for reading machine-readable code, for instance if the content is a code such as a QR code. Then, in a step S7, the recognized content is assigned to a vehicle function, for example by means of known parsing or classification methods. For example, a recognized address can thus be assigned to the “navigation system” vehicle function, a recognized piece of music to the “music player” vehicle function, etc. It is also possible, if applicable, to use for the assignment further optical features such as formatting, color, etc., for instance in order to open a particular streaming provider, or to use data from a code.

In a step S8, the appropriately assigned vehicle function is then controlled depending on the recognized content. The control of a vehicle function can comprise in particular opening or running a vehicle function, which is associated with recognized content, in particular depending on the recognized content, i.e. the vehicle function is configured using the recognized content. For example, if the content 22 is an address, the “navigation system” vehicle function 9 can be opened directly with the address as the set destination address, thus dispensing with entering the address manually in the navigation system in the vehicle. If it is a recognized piece of music, a streaming provider can be opened directly with the recognized piece of music, etc.

The control of a vehicle function can also comprise, however, just displaying data associated with recognized content, for instance on a screen 8 of the vehicle, in particular on a display of the infotainment system. Then, if applicable, it can be provided to offer a prompt for confirmation by the user, for example confirming whether the recognized content is correct and/or whether a function associated with the recognized content is meant to be run. For example: “The following address was recognized. Do you want to start the directions to the destination?”. “The following piece of music was recognized. Do you want to play it?”, etc.

While at least one exemplary embodiment has been described above, it should be noted that a large number of variations thereof exist. It should also be mentioned that the described exemplary embodiments constitute only non-limiting examples, and it is not intended for these to restrict the scope, applicability or configuration of the apparatuses and methods described herein. In fact, the above description will provide a person skilled in the art with guidance on implementing at least one exemplary embodiment, with it being understood that various changes to the manner of operation and arrangement of the elements described in an exemplary embodiment can be made without thereby departing from the subject matter specified in each of the accompanying claims or from its legal equivalent.

LIST OF REFERENCES

| | |
|---|---|
| 100 | method for controlling a vehicle function |
| 1 | vehicle interior |
| 2 | terminal (smartphone) |
| 3 | monitoring apparatus (IR camera) |
| 4 | image capture apparatus (RGB camera) |
| 5 | interior-mirror base |
| 6 | interior mirror |
| 7 | region |
| 8 | display, infotainment system |
| 9 | vehicle function |
| 10 | user (driver) |
| 21 | display, terminal (smartphone) |
| 22 | displayed content |

1.-15. (canceled)

16. A method for controlling a function of a vehicle by means of a terminal of a user, the method comprising:
capturing image data using at least one image capture apparatus in an interior of the vehicle, wherein the image data contains at least one view of the terminal of the user;
recognizing content on the terminal of the user by analyzing the image data to generated recognized content;
assigning the recognized content to a function of the vehicle; and
controlling the function of the vehicle depending on the recognized content.

17. The method as claimed in claim 16, wherein the method further comprises, before capturing of the image data:
capturing monitoring data for at least part of the interior of the vehicle using at least one monitoring apparatus;
verifying whether the terminal of the user is located at least partially in a specified region of the monitoring data;
wherein capturing of the image data is carried out only responsive to verifying that the terminal of the user is located at least partially in the specified region.

18. The method as claimed in claim 17, further comprising:
recognizing a state of the terminal by analyzing the monitoring data to generate a recognized state; and
verifying whether the recognized state is suitable for recognizing content on the terminal of the user;
wherein the recognizing of content on the terminal of the user is carried out only responsive to verifying that the state of the terminal is suitable for recognizing content on the terminal.

19. The method as claimed in claim 18, wherein:
the state comprises a position of the terminal in the interior of the vehicle; and
verifying whether the recognized state is suitable further comprises determining that the recognized state is unsuitable for recognizing content on the terminal if a separation between the terminal and the image capture apparatus lies outside a specified range.

20. The method as claimed in claim 19, wherein:
the state further comprises an orientation of the terminal in the interior of the vehicle; and
verifying whether the recognized state is suitable further comprises determining that the recognized state is unsuitable for recognizing content on the terminal if an angle of view of the image capture apparatus onto the terminal lies outside a specified range.

21. The method as claimed in claim 19, wherein:
the state comprises a portion of the terminal that is visible to the image capture apparatus; and
verifying whether the recognized state is suitable further comprises determining that the recognized state is unsuitable for recognizing content on the terminal if the portion is less than a specified limit value.

22. The method as claimed in claim 19, wherein:
the state comprises a movement of the terminal; and
verifying whether the recognized state is suitable further comprises determining that the recognized state is unsuitable for recognizing content on the terminal if the movement is greater than a specified limit value.

23. The method as claimed in claim 18, wherein:
the state comprises a portion of the terminal that is visible to the image capture apparatus; and
verifying whether the recognized state is suitable further comprises determining that the recognized state is unsuitable for recognizing content on the terminal if the portion is less than a specified limit value.

24. The method as claimed in claim 18, wherein:
the state comprises a movement of the terminal; and
verifying whether the recognized state is suitable further comprises determining that the recognized state is unsuitable for recognizing content on the terminal if the movement is greater than a specified limit value.

25. The method as claimed in claim 17, further comprising, before recognizing the content on the terminal of the user:
determining a segment of the image data, which segment represents the terminal, from the monitoring data; and
verifying whether the segment contains image data suitable for recognizing content on the terminal of the user;
wherein recognizing the content on the terminal is carried out only if it is verified that the segment contains image data suitable for recognizing content on the terminal.

26. The method as claimed in claim 16, wherein the image data is captured in a visible region of light using the image capture apparatus.

27. The method as claimed in claim 16, wherein the monitoring data is captured using the monitoring apparatus as image data in the infrared light region, and/or as three-dimensional model data.

28. The method as claimed in claim 16, wherein the monitoring data is captured using the monitoring apparatus as three-dimensional model data.

29. The method as claimed in claim 16, wherein recognizing the content comprises recognizing text and/or recognizing machine-readable code.

30. A system for data processing having at least one processor which is configured to perform the method as claimed in claim 16.

31. The system as claimed in claim 30, further comprising the at least one image capture apparatus, and wherein the at least one image capture apparatus is configured to capture image data in the visible region of light.

32. The system as claimed in claim 30, further comprising at least one monitoring apparatus configured to capture monitoring data for at least part of the interior of the vehicle; and
wherein capturing the image data is carried out only responsive to verifying that the terminal of the user is located at least partially in a specified region of the monitoring data.

33. A non-transitory storage medium having a computer program product having instructions which, on being executed on one or more processing devices, performs a method comprising:
obtaining image data from at least one image capture apparatus in an interior of the vehicle, wherein the image data contains at least one view of the terminal of the user;
recognizing content on the terminal of the user by analyzing the image data to generated recognized content;
assigning the recognized content to a function of the vehicle; and
controlling the function of the vehicle depending on the recognized content.
